(19) United States
(12) Patent Application Publication
(10) Pub. No.: US 2008/0319565 A1
(43) Pub. Date: Dec. 25, 2008

(54) SYSTEM AND METHODS FOR MANAGING PROCESS FLOW CHANGES

(75) Inventors: David P. Colon, Newburgh, NY (US); Bradley P. Jones, Pleasant Valley, NY (US); Jason J. Mazzotti, Wappingers Falls, NY (US); Richard P. Volant, New Fairfield, CT (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/767,686

(22) Filed: Jun. 25, 2007

(51) Int. Cl. G06F 19/00

(52) U.S. Cl. 700/96

(57) ABSTRACT

A computer program product for performing automated error checking in an automated production line, includes instructions for: receiving change information for changing a production process; comparing the change information to standard information for the production process; and reporting information from the comparing. Manufacturing execution software and a system for employing the manufacturing execution software are provided.

### BACKGROUND OF THE INVENTION

1. Field of the Invention

The teachings herein relate to systems for managing processes, and in particular to techniques for timely management of process changes.

2. Description of the Related Art

Many production environments are complex and call for complicated process management and controls. Software systems satisfy many aspects required for efficient control of production. Software systems provide for improved process management in virtually every aspect of process management, including inventory control, engineering change control, purchasing control, work planning, material planning, scheduling, assembly, financial control and many other aspects. However, such systems are not without problems.

For example, when Engineering Changes (ECs) are made to a process flow or production route, errors can be made. If production is carried out in an automated assembly line, the errors may go undetected for some period of time, resulting in improper processing. More specifically, a route change may differ from what was specified in an Engineering Change Notice (ECN). Although many methods of error checking are available to process managers, these typically involve manual oversight.

What are needed are techniques for automatically detecting and controlling design errors and deviations in managed processes.

### BRIEF SUMMARY OF THE INVENTION

Disclosed is a computer program product stored on machine readable media, the product including machine executable instructions for performing automated error checking in an automated production line, the product including instructions for: receiving change information for changing a production process; comparing the change information to standard information for the production process; and reporting information from the comparing.

Also disclosed is a computer program product stored on machine readable media, the product including machine executable instructions for governing a production line, the instructions including instructions for: automatically managing production of a product; and performing automated error checking in the production by receiving change information for changing a production process; comparing the change information to standard information for the production process; and reporting information from the comparing.

Further disclosed is a system for automatically producing a product, the system including: a production line adapted for producing the product coupled to a manufacturing execution system including machine readable instructions stored on machine readable media, the instructions including machine executable instructions for automatically managing production of a product; and performing automated error checking in the production by receiving change information for changing a production process; comparing the change information to standard information for the production process; and reporting information from the comparing.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts components of a processing system for implementing the teachings herein;

FIG. 2 depicts an exemplary architecture for manufacturing execution software;

FIG. 3 is a flow chart providing an overview of automated error checking techniques;

FIG. 4 is a flow chart depicting logical aspects of a initial process change verification module;

FIG. 5 is a flow chart depicting further logical aspects of the module of FIG. 4;

FIG. 6 is a flow chart depicting logical aspects of a simulator module;

FIG. 7 is a flow chart depicting logical aspects of a realtime run checker;

FIG. 8 is a flow chart depicting aspects of software simulation of process flow;

FIG. 9 is a flow chart depicting aspects of actual lot comparison during production; and

FIG. 10 is a flow chart depicting aspects of actual lot comparison after production.

The detailed description explains the preferred embodiments of the invention, together with advantages and features, by way of example with reference to the drawings.

### DETAILED DESCRIPTION OF THE INVENTION

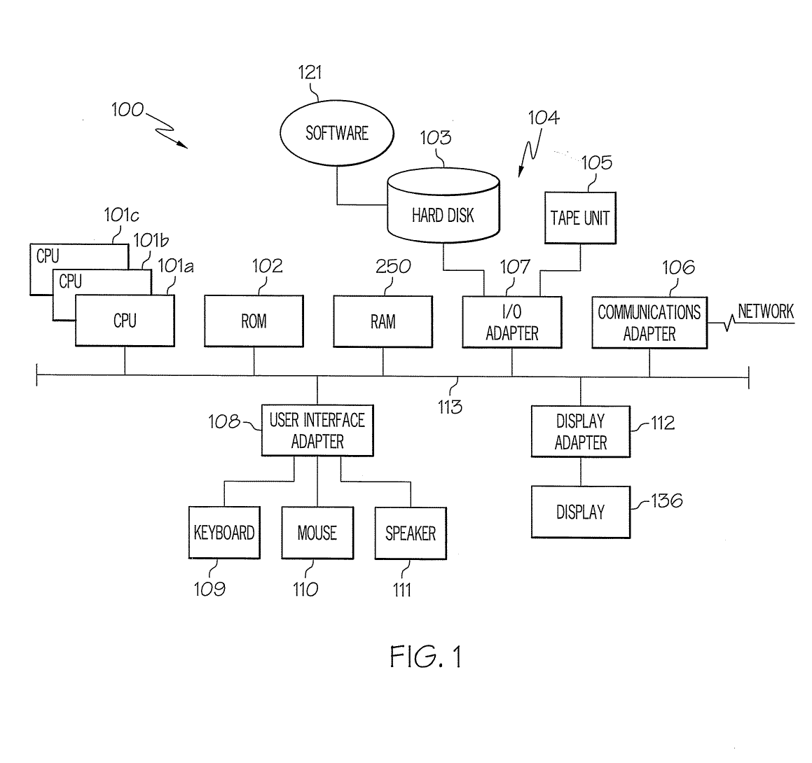

Referring to FIG. 1, there is shown an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for providing automated process control. As referred to herein, the instructions are referred to as providing for “automated” error checking software 121. The software 121 may be produced using software development tools as are known in the art.

As used herein, the term “automated” makes reference to at least partially unsupervised functionality. For example, “automated” makes reference to error checking performed by the software 121, where the error checking (or other such task) was performed in the prior art by manual techniques.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

One example of software 121 used for process management is referred to as “Siview.” Siview is a product of International Business Machines, Inc. of Armonk, N.Y. Siview is a manufacturing execution system that includes components such as a specification manager, a material manager, an automation manager, a scheduler, a web-based floor monitor, a statistical process control component, a web reporting component, a set of manufacturing common base classes and a manufacturing common system framework. The Siview system is generally adapted for server and client implementations.

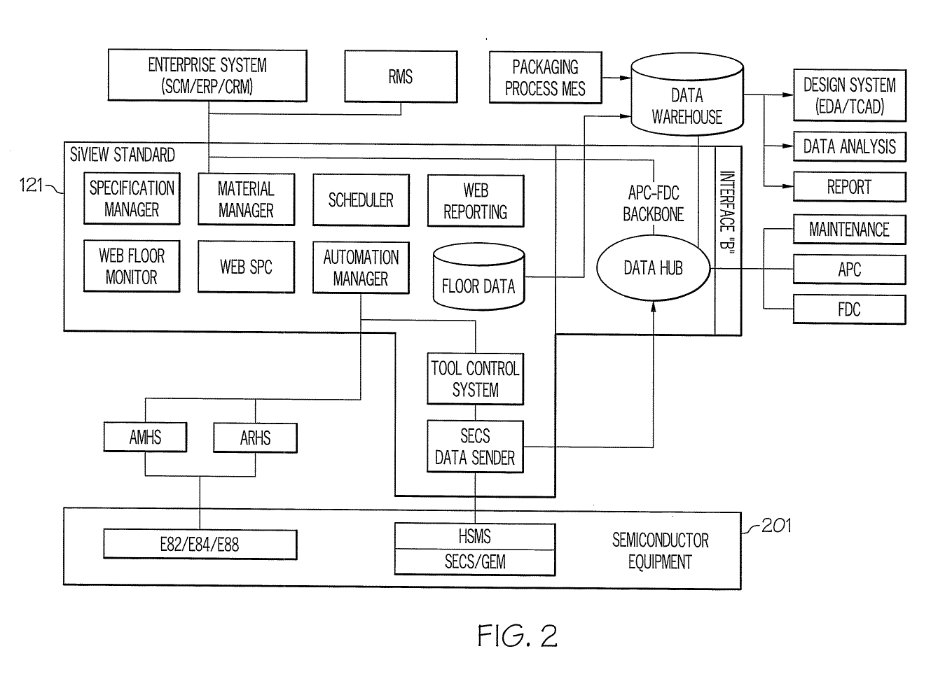

An overview of one embodiment of system architecture for the software 121 is provided in FIG. 2. In FIG. 2, a relationship with a production line 201 is shown. In this embodiment, the production line 201 includes semiconductor fabrication equipment. Further, and as an aid to understanding of FIG. 2, acronyms presented are defined: SCM Supply Chain Management, ERP Enterprise Resource Planning, CRM Customer Relationship Management, RMS Recipe Management System, EDA Electronic Design Automation, TCAD Technology Computer Aided Design, SPC Statistical Process Control, APC Advanced Process Control, FDC Fault Detection and Classification, AMHS Automated Material Handling System, ARHS Automated Reticle Handling System, HSMS High Speed Message Service, SECS SEMI Equipment Communication Standard, GEM General Equipment Model, E82 SEMI Specification for Interbay/Intrabay AMHS, E84 SEMI Specification for Enhanced Carrier Handoff Parallel I/O, E88 SEMI Specification for AMHS Storage SEM (Stocker SEM), and SEMI Semiconductor Equipment and Material International.

As discussed herein, fabrication of “product” (such as semiconductor circuits built on wafers) occurs in an assembly “route.” Product may be fabricated in lots. Various routes may exist in any one production line 201. When a change is made in the fabrication, “engineering change notices (ECN)” (also referred to as “EC”) may be generated and used to effect the change. “Work in progress” (WIP) documents may be produced for at least one of review and analysis of production and to evaluate aspects such as conformity to design specifications, changes, and phased-in or phased-out standards and the like. Documentation, such as ECN and WIP may be added manually into the software 121.

The teachings herein provide for automatically reviewing process instructions for all products being fabricated on each route of the production line 201. In general, for each changed operation, the route of the first lot to reach the operation is compared to a route segment that is listed in an ECN form. This may be performed for each product type included in the ECN, until all product types have been checked. The checking may be repeated on a number of lots or for a period of time, to take into account phase-ins (where only a fraction of the WIP is processed by the new route), optional operations (e.g. measurements & inspections), and tools being dedicated to one process for a period of time and another process for another period, etc.

In various embodiments, error checking is accomplished over a selected sequence of steps from the production process. That is, error checking need not consider an entire route or other such segment of production, and may consider only selected segments thereof. Error checking may be performed on a realtime basis. That is, error checking may be performed in a manner that provides users with ability to detect errors during production, wherein the detection is completed at a rate of production, or generally near the rate of production.

The teachings herein provide for automatic detection of errors that may occur when a route is initially written or changed. In one embodiment, the teachings provide for Route Review. In this embodiment, a new route is reviewed and compared to an old route by the EC originator and experts familiar with the process flow. This finds errors (i.e., differences) that are directly in the route, but not in related objects or in subroutines or conditional operations that may be called for by the route. Deviations (i.e., insignificant errors) may be overlooked.

In another aspect, the teachings provide for Post Change Verification. More specifically, after the EC is implemented, the process history of the first product run is reviewed by the EC originator and experts familiar with the process flow. Post Change Verification finds an error after a respective lot has been misprocessed. This increases a level accuracy typically not achieved in the prior art, such as where a high degree of diligence was required to cover all cases of all changes on rarely used routes, and where deviations might have been overlooked.

Another aspect of the software 121 is evaluation of Product Measurement and Test data. For example, shortly after the EC is implemented, the relevant product measurement and test data of the first product run may be reviewed by the EC originator and experts familiar with the process flow. One skilled in the art will note that not all change errors are detectable by a measurement or test. The measurement or test may be a long time after the erroneous step in the route and a large amount of product could be improperly processed before the error is detected.

If the route system calls for a process different in any way from what is listed in the ECN, the system may hold the wafer and/or inhibit the process instruction from further use until an engineering review has been performed.

The example of a production environment provided below is of semiconductor wafer processing. In this example, the process route is controlled by Siview. One skilled in the art will recognize that many adaptations may be had, and that aspects of the software 121 many be used to manage fabrication (production or manufacture) of many product types on a variety of assembly lines, wherein such fabrication is generally controlled by manufacturing execution software (a computer program product having machine readable instructions and stored on machine readable media, the program for governing manufacturing execution).

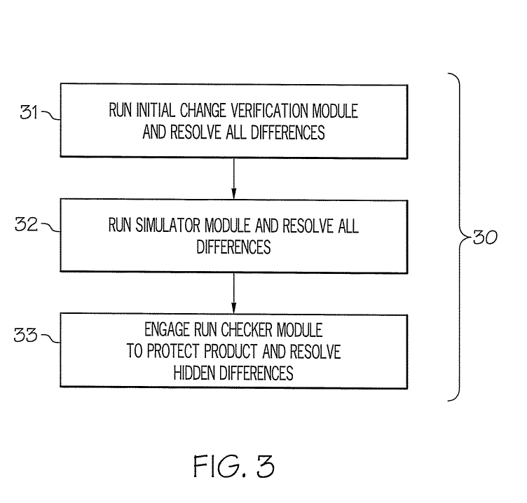

Referring now to FIG. 3, there is shown an overview of exemplary steps performed by the software 121. That is, the software 121 as shown in FIG. 3 implements a method for error checking 30. First, the method for error checking 30 calls for verifying initial process changes 31. Next, the method for error checking 30 calls for simulating process flow 32. Subsequently, the method for error checking 30 calls for run checking 33. Each of these steps are described now in greater detail.

The method for error checking first calls for verifying initial process changes 31. This may be accomplished by use of an Initial Change Verification module included within the software. As an example, in verification, an Engineering Change (EC) request is placed. Data from the EC is input into the software 121 along with the process programming that was generated from the EC request. Then, a prior known good process or a “reference standard” process is selected for comparison. The reference standard may be referred to as a “golden standard.” The reference standard contains, among other things, reference information or standard information that is descriptive of the golden standard and useful for comparisons. Following this, the software 121 runs through the selected process, which may be only a subsection of an entire process, and reports any differences between the changed process and the golden standard. Often, the range of related processes being checked have a margin (for example, additional sequence information) on one or both ends of the change requested in order to avoid accidental redundancies and assure proper parity and sequencing.

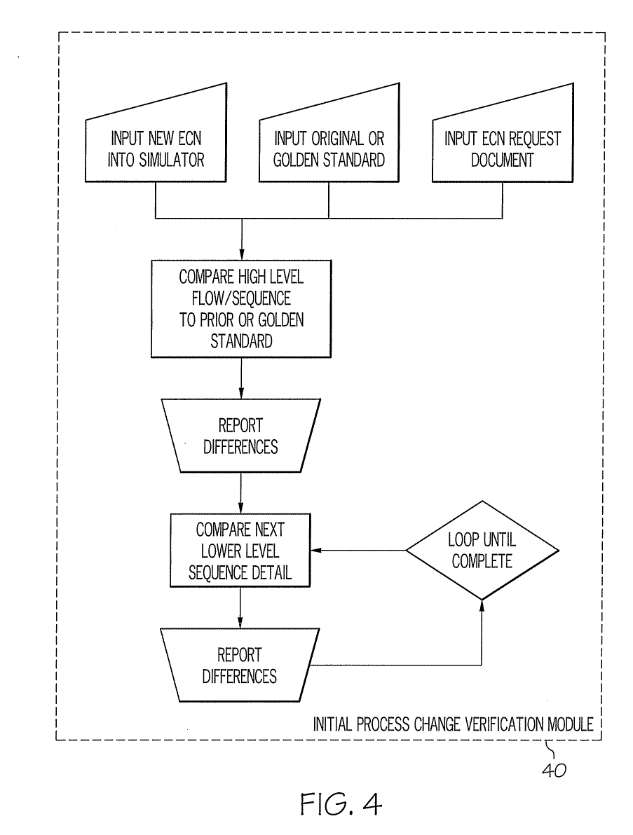

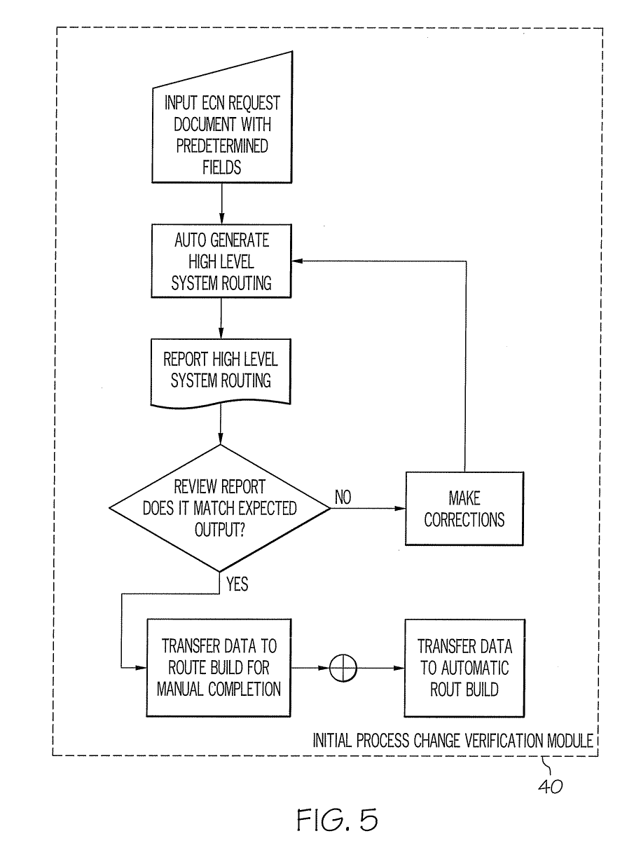

Initial change verification may be performed using a module that is included as a part of the software 121. Exemplary aspects of an Initial Process Change Verification Module 40 are depicted in FIGS. 4 and 5. As shown in FIG. 5, verification may provide for making corrections to the ECN and ultimately to building route information for process execution.

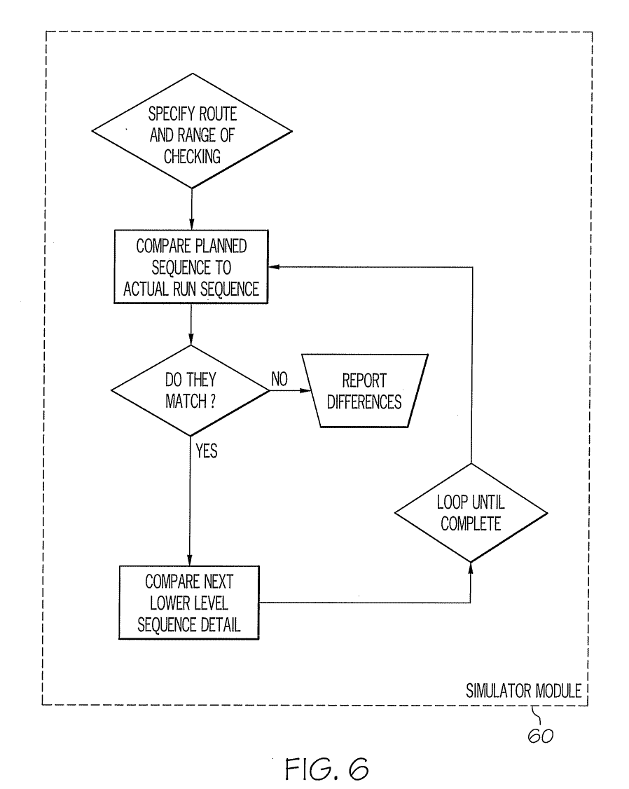

Simulating process flow may be accomplished by a process flow simulator module included within the software 121. One example of the simulator module 60 is provided in FIG. 6. As an example of simulating process flow 32, consider an embodiment where an EC is made on a software object, such as a main process definition, module, operation, process definition, logical recipe, equipment recipe, tool id, or measurement specification. In this example, a software simulator processes a virtual lot of wafers through the process objects contained in the ECN, or starts the comparison a few steps before the point of change, and continues a few steps after the change. Next, a software comparison is made between the history of the simulated lots, the ECN, and a golden lot (or last good lot processed with the old Process of Record (POR)). In some embodiments, comparison starts with the highest level, most general object (e.g. Main process definition (PD)) and continues down to the lowest level, most narrow, specific objects (e.g. Equipment Recipe, tool identification (ID), measurement spec). Next, the comparison reports any commonalities and differences between the history of the simulated lots, the ECN, and the golden lot. Finally, a comparison report is reviewed by the EC originator and experts familiar with the process flow, to determine whether identified commonalities and differences are intentional.

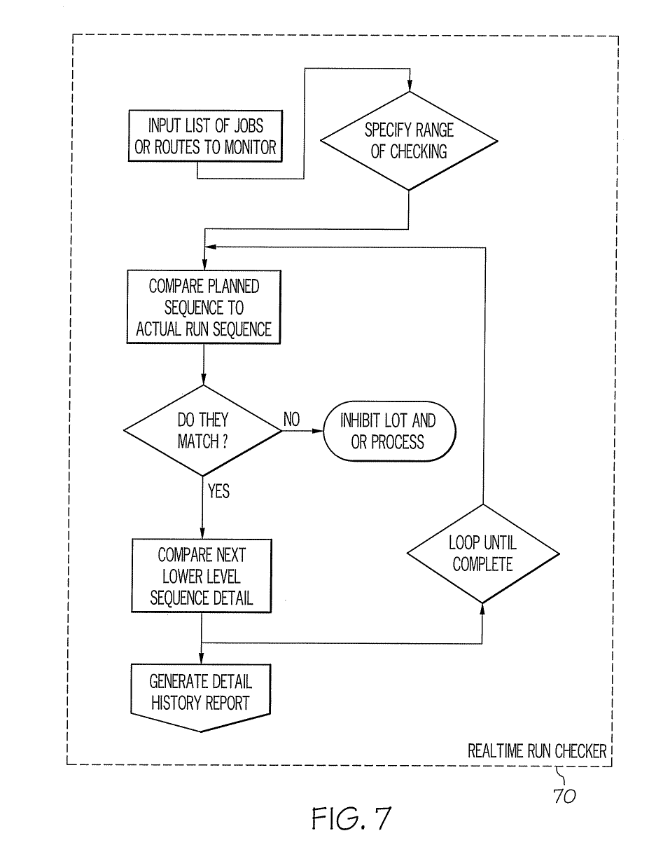

Realtime run checking may be completed by a realtime run checker module included within the software 121. An exemplary realtime run checker module 70 is depicted in FIG. 7. Once simulation is completed, realtime run checking may be performed. Realtime run checking may call for comparing of lots during actual production. To illustrate this comparison, consider an embodiment where an EC is made on a software object, such as a main process definition, module, operation, process definition, logical recipe, equipment recipe, tool id, or measurement specification. Once the EC is made, an actual product lot, or number of lots, is processed, often one step at a time, through the process objects contained in the ECN. Before each step, a software comparison may be made between instructions being issued on the actual lot, the ECN, and a golden lot (or last good lot processed with the old Process of Record (POR)). As in some other steps, comparison may start with the highest level, most general object (e.g. Main PD) and continues down to the lowest level, most narrow, specific objects (e.g. Equipment Recipe, tool ID, measurement spec). The comparison may be done on the ECN steps only, or it may start a few steps before the point of change, and continue a few steps after the last step of the change. Next, the comparison reports identified commonalities and differences between the history of the simulated lots, the ECN, and the golden lot. If a difference (i.e., a non-conforming condition that qualifies as an error) is found between the current lot instructions and the ECN, the system at least one of holds the wafer and inhibits the process instruction from further use until an engineering review has been done (i.e., the system stops production). This embodiment is advantageous in that this solution does not permit a lot to be misprocessed to completion.

Comparing of lots post production follows a similar procedure. As a non-limiting example, consider steps where an EC is made on a software object, such as a main process definition, module, operation, process definition, logical recipe, equipment recipe, tool id, or measurement specification. An actual product lot, or number of lots, is processed through the process objects contained in the ECN. Again, a software comparison is made between the history of the actual lot, the ECN, and a golden lot (or last good lot processed with the old Process of Record (POR)). The comparison may start with the highest level, most general object (e.g. Main PD) and continues down to the lowest level, most narrow, specific objects (e.g. Equipment Recipe, tool ID, measurement spec). The comparison may be done on the ECN steps only, or it may start a few steps before the point of change, and continue a few steps after the last step of the change. Next, the comparison reports identified commonalities and differences between the history of the simulated lots, the ECN, and the golden lot. If a difference (i.e., a non-conforming condition that qualifies as an error) is found between the current lot instructions and the ECN, the system at least one of holds the wafer and inhibits the process instruction from further use until an engineering review has been done (i.e., the system stops production). This embodiment is advantageous in that this solution does not permit a lot to be misprocessed to completion.

In some embodiments, all of the steps of the method for error checking 30 are completed. However, it should be recognized that certain portions of steps or complete steps of the method may be omitted. For example, comparison during production may be omitted in the interest of expedited production of increased throughput. Accordingly, the foregoing methods and examples are merely illustrative and are not limiting of the teachings herein.

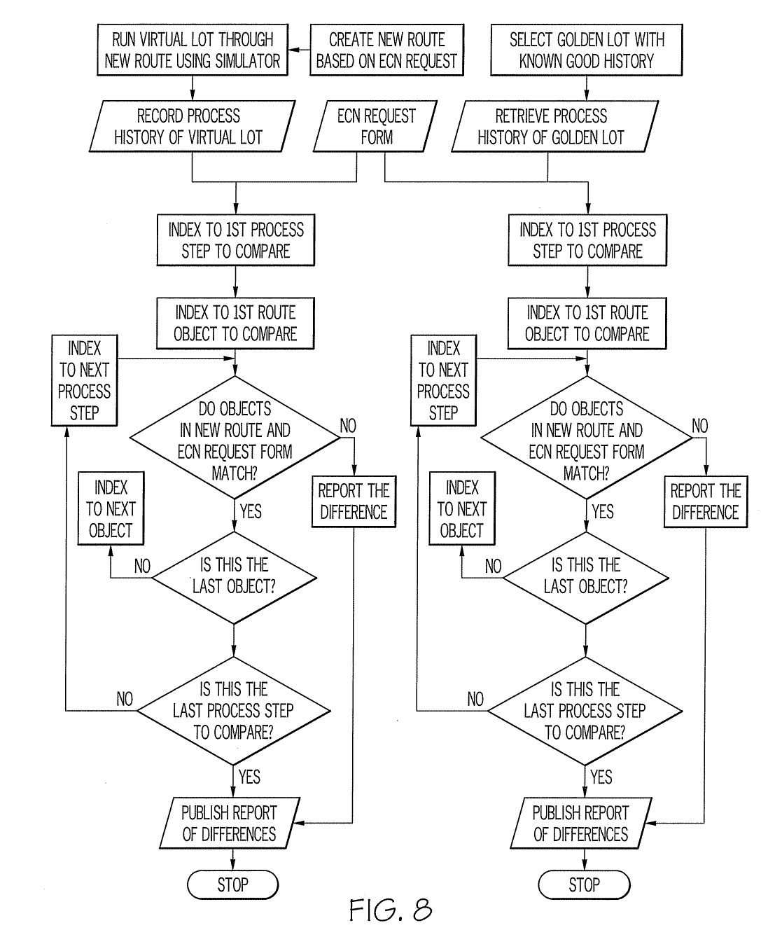

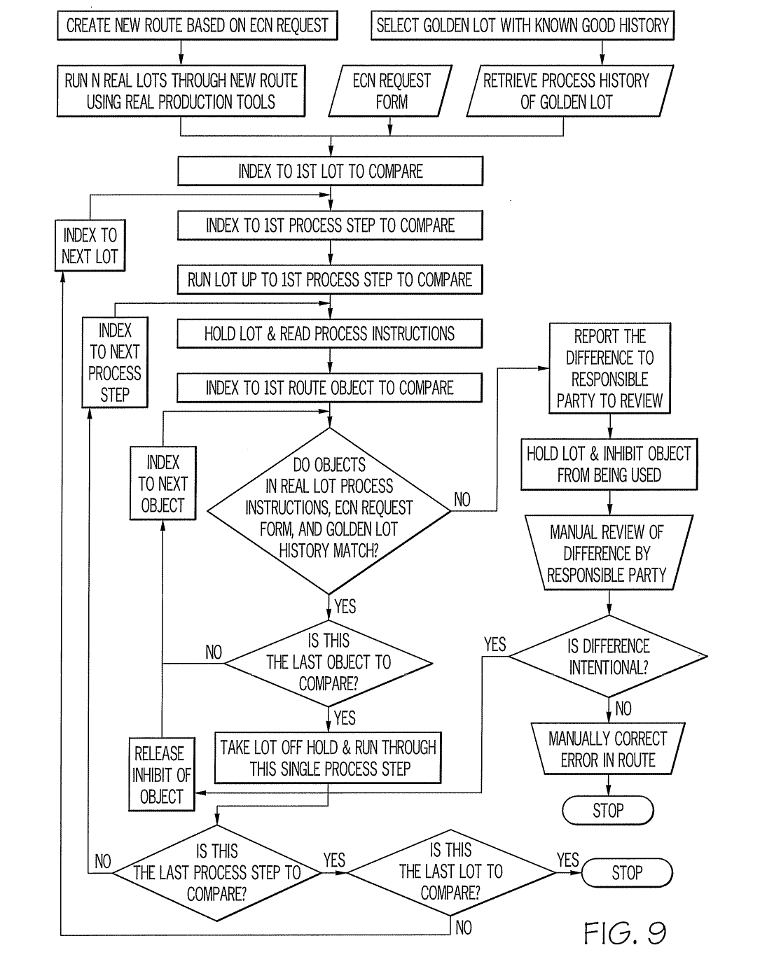

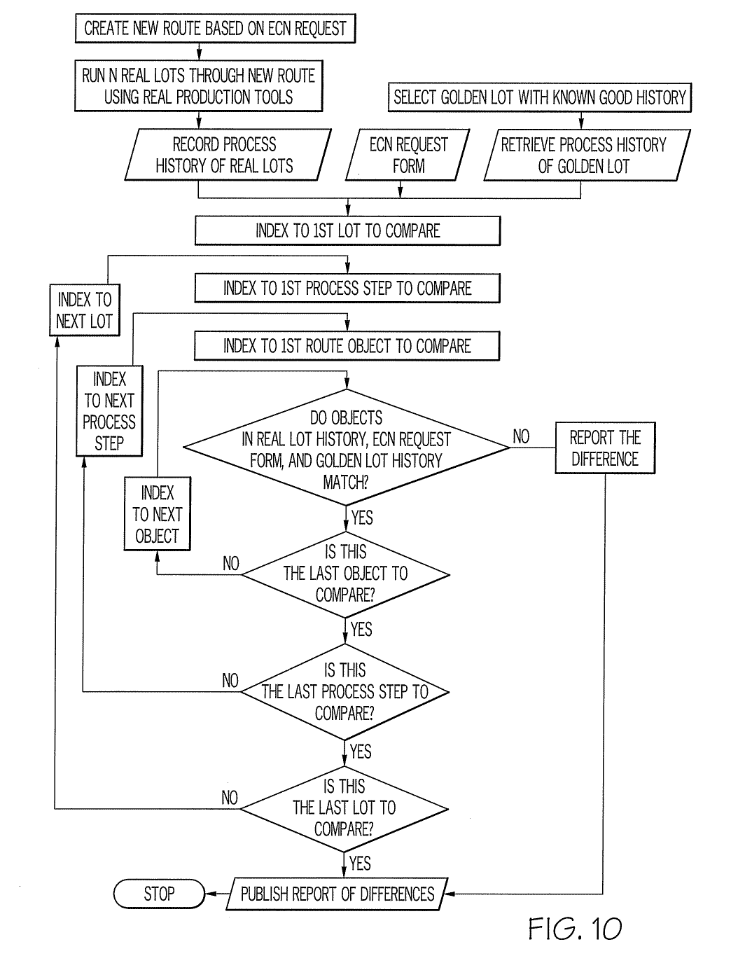

For further detail, reference may be had to FIGS. 8, 9 and 10, where FIG. 8 provides detail of an exemplary embodiment for simulating process flow 32; FIG. 9 provides detail of an exemplary embodiment for comparing during production; and FIG. 10 provides detail of an exemplary embodiment for comparing post production.

FIG. 8 depicts an error checking algorithm to be used after a change is made in the MES software, but before the product is processed with the new instructions. First, an Engineering Change (EC) is made regarding a software object, such as at least one of main process definition, module, operation, process definition, logical recipe, equipment recipe, tool id and measurement specification. Next, a software simulator processes a virtual lot of product through the process objects contained in the ECN. Optionally, the comparison starts a few steps before the point of change, and continues a few steps after the change. The software compares the history of the simulated lots, the ECN, and a golden lot (or last good lot processed with the old Process of Record (POR)). The comparison starts with the highest level, most general object (e.g. Main PD) and continues down to the lowest level, most narrow, specific objects (e.g. Equipment Recipe, tool ID, measurement spec). Then the comparison reports the commonalities and differences between the ECN and the histories of the simulated lots, and the golden lot. Finally, the report is reviewed by the EC originator and experts familiar with the process flow, to determine whether the commonalities & differences are intentional.

FIG. 9 depicts an error checking algorithm to be performed when the first product reaches the point of process change (actual lot comparison during production). First, an EC is made on a software object, such as at least one of a main process definition, module, operation, process definition, logical recipe, equipment recipe, tool id and measurement specification. Next, actual product, is processed, one step at a time, through the process objects contained in the ECN. Before each step, a software comparison is made between the instructions being issued on the actual lot, the ECN, and a golden lot (or last good lot processed with the old Process of Record (POR)). The comparison starts with the highest level, most general object (e.g. Main PD) and continues down to the lowest level, most narrow, specific objects (e.g. Equipment Recipe, tool ID, measurement spec). Optionally, the comparison starts a few steps before the point of change, and continues a few steps after the change. Then, the comparison reports the commonalities and differences between the history of the simulated lots, the ECN, and the golden lot. Finally, if a difference is found between the current lot instructions and the ECN, the system holds the wafer and/or inhibits the process instruction from further use until an engineering review has been done. This solution prevents product from being misprocessed by detecting the error before the product is processed.

FIG. 10 describes the algorithm for the post-processing error checking. First an EC is made on a software object, such as at least one of a main process definition, module, operation, process definition, logical recipe, equipment recipe, tool id and a measurement specification. Then an actual product lot, or number of lots, is processed through the process objects contained in the ECN. Next a software comparison is made between the history of the actual lot, the ECN, and a golden lot (or last good lot processed with the old Process of Record (POR)). The comparison starts with the highest level, most general object (e.g. Main PD) and continues down to the lowest level, most narrow, specific objects (e.g. Equipment Recipe, tool ID, measurement spec). The comparison can be done on the ECN steps only, or it may start a few steps before the point of change, and continue a few steps after the last step of the change. Now the comparison reports the commonalities and differences between the history of the simulated lots, the ECN, and the golden lot. The report may be reviewed by the EC originator and experts familiar with the process flow to determine, for example, whether the commonalities and differences are intentional.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer program product stored on machine readable media, the product comprising machine executable instructions for performing automated error checking in an automated production line, the product comprising instructions for:
receiving change information for changing a production process;
comparing the change information to standard information for the production process; and
reporting information from the comparing.

2. The computer program product as in claim 1, further comprising instructions for simulating the production process.

3. The computer program product as in claim 1, wherein the change information comprises at least one of a main process definition, an equipment recipe, a tool identification and measurement specifications.

4. The computer program product as in claim 1, wherein the change information comprises instructions for at least one of the changed production process and product produced by the changed production process.

5. The computer program product as in claim 1, wherein the standard information comprises instructions for at least one of a standard production process and product produced by the standard production process.

6. The computer program product as in claim 1, wherein the automated error checking is performed at least one of prior to production, during production, and after production.

7. The computer program product as in claim 1, wherein information from the comparing comprises information regarding at least one of commonalities and differences between the changed production process and the standard production process.

8. The computer program product as in claim 1, further comprising instructions for stopping production if an error is detected.

9. The computer program product as in claim 1, further comprising instructions for modifying the change information.

10. A computer program product stored on machine readable media, the product comprising machine executable instructions for governing a production line, the instructions comprising instructions for:
automatically managing production of a product; and
performing automated error checking in the production by receiving change information for changing a production process; comparing the change information to standard information for the production process; and reporting information from the comparing.

11. The computer program product as in claim 10, wherein the product comprises components comprising at least one of a specification manager, a material manager, an automation manager, a scheduler, a web-based floor monitor, a statistical process control component, a web reporting component, a set of manufacturing common base classes and a manufacturing common system framework.

12. A system for automatically producing a product, the system comprising:
a production line adapted for producing the product coupled to a manufacturing execution system comprising machine readable instructions stored on machine readable media, the instructions comprising machine executable instructions for automatically managing production of a product; and performing automated error checking in the production by receiving change information for changing a production process; comparing the change information to standard information for the production process; and reporting information from the comparing.
